(19) United States
(12) Patent Application Publication
(10) Pub. No.: US 2007/0097003 A1
(43) Pub. Date: May 3, 2007

(54) Antenna device, antenna noncontact data transmitter and receiver, communicator sheet, communicator loop, and antenna sheet

(75) Inventors: Sho Sasaki, Nara-shi (JP); Tomonori Seki, Nara-shi (JP); Toshinari Mori, Nara-shi (JP); Natsuko Horiguchi, Kyoto-shi (JP)

Correspondence Address: OSHA LIANG L.L.P., 1221 MCKINNEY STREET, SUITE 2800, HOUSTON, TX, 77010, US

(73) Assignee: OMRON Corporation, Kyoto (JP)

(21) Appl. No.: 11/589,678

(22) Filed: Oct. 30, 2006

(30) Foreign Application Priority Data
Sep. 15, 2006 (JP) JP2006-251861
Oct. 28, 2005 (JP) 2005-315456

(51) Int. Cl. H01Q 11/12

(52) U.S. Cl. 343/742; 343/741

(57) ABSTRACT

An antenna device and non-contact transmitter/receiver device constituting at least the same includes a first conductor unit; a second conductor unit that is electrically connected to the first conductor unit; and a third conductor unit that is electrically connected to the first conductor unit and the second conductor unit. The first conductor is placed along a first virtual plane, the second conductor unit is placed along a second virtual plane, and the third conductor is placed along a third virtual plane. In this antenna, the plane that includes the first conductor unit, the plane that includes the second conductor unit, and the plane that includes the third conductor unit are perpendicular to one another.

### BACKGROUND

1. Field of the Invention

The present invention relates to an antenna of a RFID communicator (such as a noncontact data transmitter and receiver).

2. Description of the Related Art

In recent years, attention has been drawn to RFID (Radio Frequency Identification) as a system for inventory control, etc. in the introduction of IT and automation to the society. A noncontact data transmitter and receiver using RFID includes an antenna and an IC chip that performs data processing and other functions.

Such a noncontact data transmitter and receiver communicates with external devices through radio waves or electromagnetic waves. For example, when receiving radio waves (including a control signal) generated from an external device, the noncontact data transmitter and receiver generates (induced) electromotive force through the operation of the antenna (the antenna of the noncontact data transmitter and receiver). Using the electromotive force, the IC chip performs data processing in accordance with the control signal, and the processing result is transmitted through radio waves from the antenna. The external device receives and reads the processing result.

Such a noncontact data transmitter and receiver is expected to have more functions added in the future, and a high-performance antenna is essential in the noncontact data transmitter and receiver. In this trend, there is an increasing demand for antennas that can efficiently receive radio waves from various directions. Such built-in antennas are disclosed in Japanese Patent Application Laid-Open Nos. 2001-156526 (publication date: Jun. 8, 2001), 2004-260586 (publication date: Sep. 16, 2004), and 2000-339069 (publication date: Jun. 6, 2000).

However, the two-dimensional antenna disclosed in Japanese Patent Application Laid-Open No. 2001-156526 needs to change orientations in accordance with the direction of radio waves, which causes inconvenience. Also, three-dimensional antennas that can receive radio waves from various directions shown in FIGS. 15A and 15B have been suggested. For example, with radio waves being generated from three directions, three conductor loops (X, Y, Z) are formed, and are connected in parallel with one another (see FIG. 15A) or connected in series (see FIG. 15B). However, as the shapes of the antennas are complicated, the production costs are large. As shown in FIGS. 15A and 15B, the load on the entire antenna is equivalent to the load of 12 sides (the total number of sides of X, Y, and Z), with the conductor for each direction (each conductor loop) having four sides. As a result, large power loss is caused (or the amount of power that can be consumed at a circuit such as an IC chip becomes small).

### SUMMARY

Embodiments of the present invention provide antennas (such as antennas for noncontact data transmitters and receivers) that can receive radio waves from various directions with efficiency.

In accordance with one aspect of the present invention, an antenna device comprises: a holding material; and first through third conductor units that are provided on the holding material; wherein the holding material has first through third planes that share one corner and are perpendicular to one another, the first conductor unit is placed along the first plane, the second conductor unit is placed along the second plane, and the third conductor unit is placed along the third plane.

In accordance with one aspect of the present invention, an antenna device comprises: a first conductor unit: a second conductor unit that is electrically connected to the first conductor unit; a third conductor unit that is electrically connected to the first conductor unit and the second conductor unit; a first holding material that holds at least part of the first conductor unit; a second holding material that holds at least part of the second conductor unit; and a third holding material that holds at least part of the third conductor unit; wherein the plane that includes the first conductor unit, the plane that includes the second conductor unit, and the plane that includes the third conductor unit are perpendicular to one another.

In accordance with one aspect of the present invention, an antenna comprises:

first through third conductor units, wherein first through third planes are three virtual planes that share one point and are perpendicular to one another, the first through third conductor units are connected to one another, the first conductor unit is placed along the first plane; the second conductor unit is placed along the second plane; and the third conductor unit is placed along the third plane.

In accordance with one aspect of the present invention, a noncontact data transmitter and receiver comprises: an antenna; and an IC chip that is connected to the antenna; wherein the antenna comprises first through third conductor units wherein first through third planes being three virtual planes that share one point and are perpendicular to one another, the first through third conductor units being connected to one another so as to form a loop-like shape, the first conductor unit being placed along the first plane, the second conductor unit being placed along the second plane, the third conductor unit is placed along the third plane; the IC chip performs an operation in accordance with a control signal received by the antenna, using the electromotive force generated by radio waves including the control signal; and radio waves for transmitting the information recorded on the IC chip are generated from the antenna.

In accordance with one aspect of the present invention, an antenna sheet comprises: first through third partial sheets; first through third conductor units wherein folding is performed at the boundary between each two of the first through third partial sheets, so as to arrange the first through third partial sheets in a L-like shape and to form first through third planes that share one point and are perpendicular to one another; the first conductor unit and the second conductor unit are connected to each other; and the second conductor unit and the third conductor unit are connected to each other.

Other aspects and advantages of the invention will be apparent from the following description and the appended claims.

### BRIEF DESCRIPTION OF DRAWINGS

FIG. 1 illustrates a perspective view of the structure of a noncontact data transmitter and receiver in accordance with a first embodiment of the present invention;

FIGS. 2A and 2B illustrate schematic views of example structures of noncontact data transmitters and receivers in accordance with the first embodiment;

FIGS. 3A through 3C illustrate perspective views of other example structures of concontact data transmitters and receivers in accordance with the first embodiment;

FIGS. 4A and 4B illustrate schematic views of example structures of noncontact data transmitters and receivers in accordance with a second embodiment of the present invention;

FIG. 5 illustrates a schematic view of another example structure of a noncontact data transmitter and receiver in accordance with the second embodiment;

FIGS. 6A and 6B illustrate schematic views of example structures of noncontact data transmitters and receivers in accordance with a third embodiment of the present invention;

FIGS. 7A through 7C illustrate modifications of noncontact data transmitters and receivers in accordance with the respective embodiments;

FIG. 8 illustrates a schematic view of IC chip formation positions in accordance with each of the embodiments;

FIG. 9 illustrates a perspective view of a noncontact data transmitter and receiver attached to an object in accordance with each of the embodiments;

FIGS. 10A through 10C illustrate schematic views of example structures of communicator sheets in accordance with a fourth embodiment of the present invention;

FIGS. 11A and 11B illustrate schematic views of other example structures of communicator sheets in accordance with the fourth embodiment;

FIGS. 12A through 12D illustrate schematic view of other example structures of communicator sheets in accordance with the fourth embodiment;

FIG. 13A illustrates a schematic view of the structure of a communicator loop in accordance with a fifth embodiment of the present invention, and 13B illustrates a schematic view of the communication loop attached to an ID object in accordance with the fifth embodiment;

FIG. 14 shows a flowchart of an operation to be performed by each noncontact transmitter and receiver of the embodiments; and

FIGS. 15A and 15B illustrate schematic views of the structures of conventional antenna devices.

### DETAILED DESCRIPTION

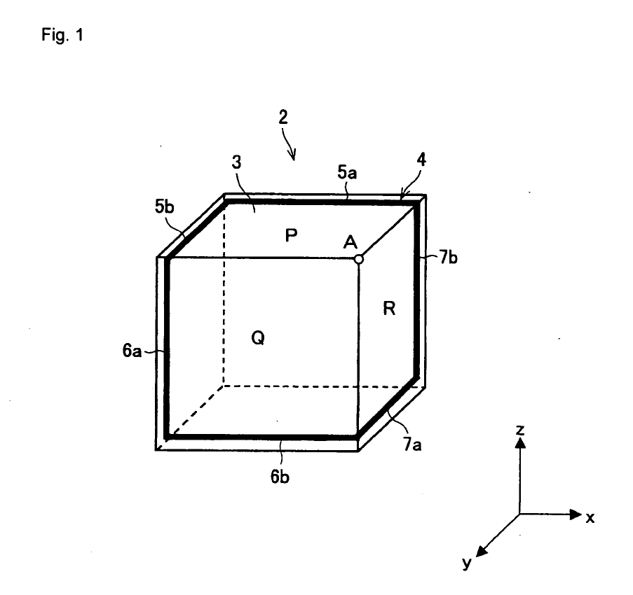

The following is a description of embodiments of the present invention, with reference to FIGS. 1 through 14.

[First Embodiment]

FIG. 1 is a perspective view of the structure of a noncontact data transmitter and receiver in accordance with this embodiment. As shown in FIG. 1, the noncontact data transmitter and receiver 2 includes an antenna device and an IC chip (not shown). The antenna device includes an antenna 4 and a holding block 3. The antenna 4 includes first conductors 5a and 5b (a first conductor unit), second conductors 6a and 6b (a second conductor unit), and third conductors 7a and 7b (a third conductor unit). In the noncontact data transmitter and receiver 2, the first through third conductors (5a, 5b, 6a, 6b, 7a, and 7b) forms a loop-like shape, and are connected to the IC chip (not shown).

Having the IC chip performing data processing and the antenna 4, the noncontact data transmitter and receiver 2 communicates with external devices through radio waves or electromagnetic waves. For example, upon receipt of radio waves (including a control signal) from an external device, the noncontact data transmitter and receiver 2 generates (induced) electromotive force by virtue of the operation of the antenna of the noncontact data transmitter and receiver 2. Using the electromotive force, the IC chip performs data processing in accordance with the control signal, and the processed result is transmitted from the antenna 4 through carrier waves.

The holding block 3 is formed by molding polyimide or another suitable substance into a rectangular parallelepiped (such as a cube), and holds the conductor units 5 through 7 in a wound state. The holding block 3 may be made of any material that does not cut off radio waves. The IC chip is attached to the holding block 3. As shown in FIG. 1, one of the corners of the holding block 3 (a rectangular parallelepiped) is “A”, and the three planes sharing the corner A and being perpendicular to one another are “P”, “Q”, and “R”. In FIG. 1, the normal directions of the planes P, Q, and R are z-direction, y-direction, and x-direction, respectively.

Here, the first conductor unit 5 (5a and 5b) is placed along the plane P (on the plane P), the second conductor unit 6 (6a and 6b) is placed along the plane Q (on the plane Q), and the third conductor unit 7 (7a and 7b) is placed along the plane R (on the plane R). The first conductors 5a and 5b are placed in the vicinities of two sides of the plane P, with the two sides being not in contact with the corner A. Accordingly, the first conductors 5a and 5b are arranged parallel to the two sides. The second conductors 6a and 6b are placed in the vicinities of two sides of the plane Q, with the two sides being not in contact with the corner A. Accordingly, the second conductors 6a and 6b are arranged parallel to the two sides. The third conductors 7a and 7b are placed in the vicinities of two sides of the plane R, with the two sides being not in contact with the corner A. Accordingly, the third conductors 7a and 7b are arranged parallel to the two sides. With the holding block 3 being a cube, for example, the antenna 4 can be projected in any of the x-, y-, and z-directions, and the areas of the respective projection figures are uniform and substantially the largest. Thus, the antenna 4 can receive radio waves (signals) with high intensity from any direction, and the reception accuracy is uniform for all the directions.

The load on the antenna 4 is only equivalent to the six sides (the first conductors 5a and 5b, the second conductors 6a and 6b, and the third conductors 7a and 7b).

Accordingly, the loss at the antenna can be halved, and the capacity of electric power that can be consumed in the circuit such as the IC chip can be made larger.

The antenna 4 has a very simple structure, with the six sides being formed into a loop-like shape along the planes P, Q, and R (the three planes that share the corner A of the rectangular parallelepiped and are perpendicular to one another). Accordingly, a two-dimensional or one-dimensional material can be readily formed into a three-dimensional structure, as will be described later. Thus, not only the production costs but also the storage and transportation costs can be dramatically reduced.

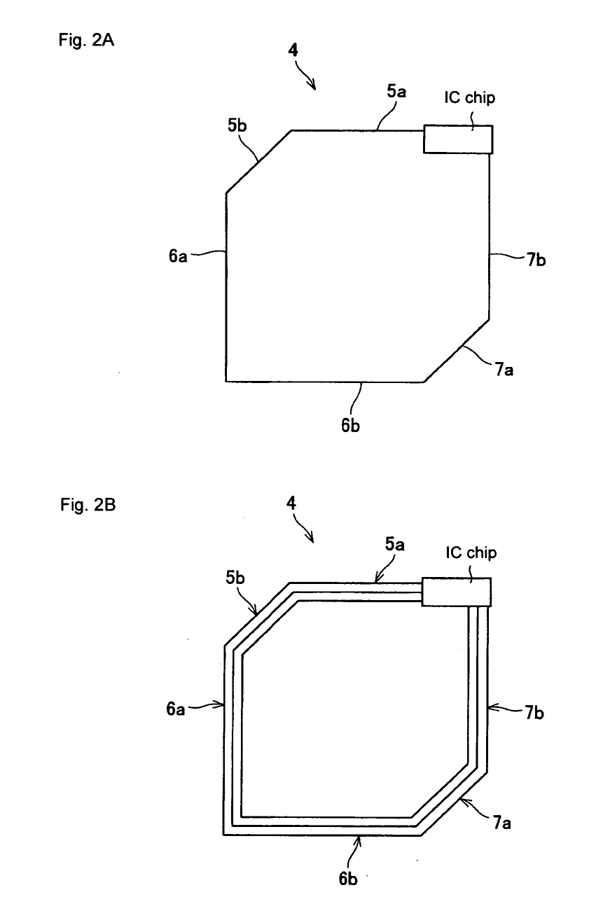

As shown in FIG. 2A, the antenna 4 is a loop formed by conductors. As shown in FIG. 2B, the antenna 4 may also be formed with several loops. In any case, the IC chip is connected to either end of the conductors. In the case of the several loops, the conductors are wound in the same direction (counterclockwise in the drawing). In the case of the several loops, each of the conductors (5a, 5b, 6a, 6b, 7a, and 7b) is formed with several conductive lines.

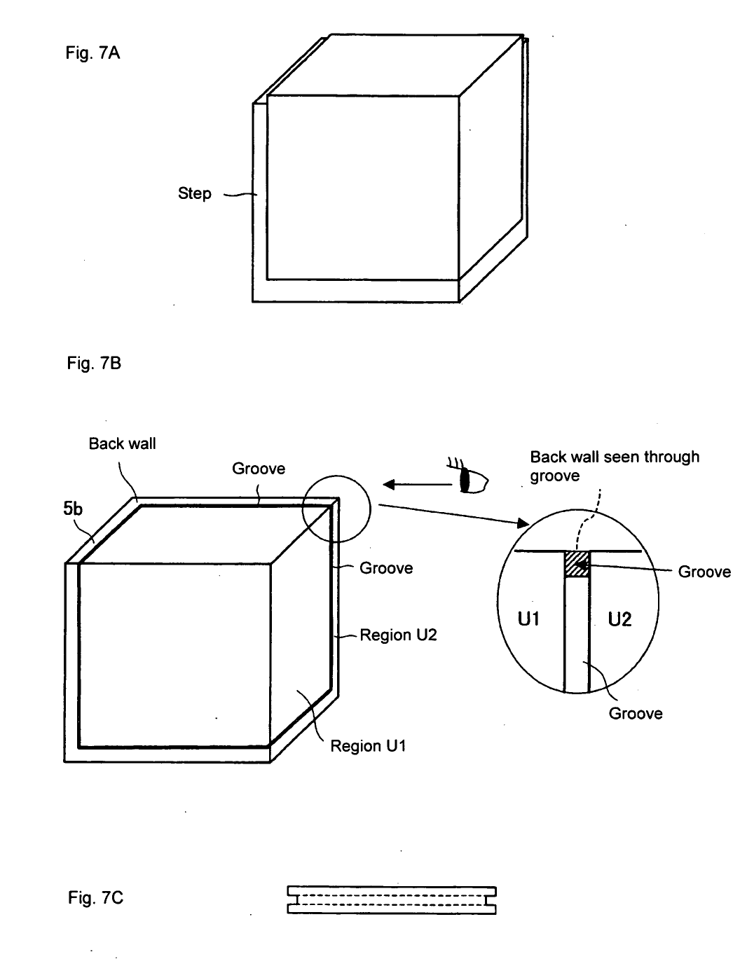

The holding block 3 has grooves or step portions at the locations at which the respective conductors are to be placed, so that the conductors can be easily wound and maintain a good wound state (see FIGS. 7A and 7B). Also, guides through which the conductors extend may be provided at the corners at which the conductors are bent.

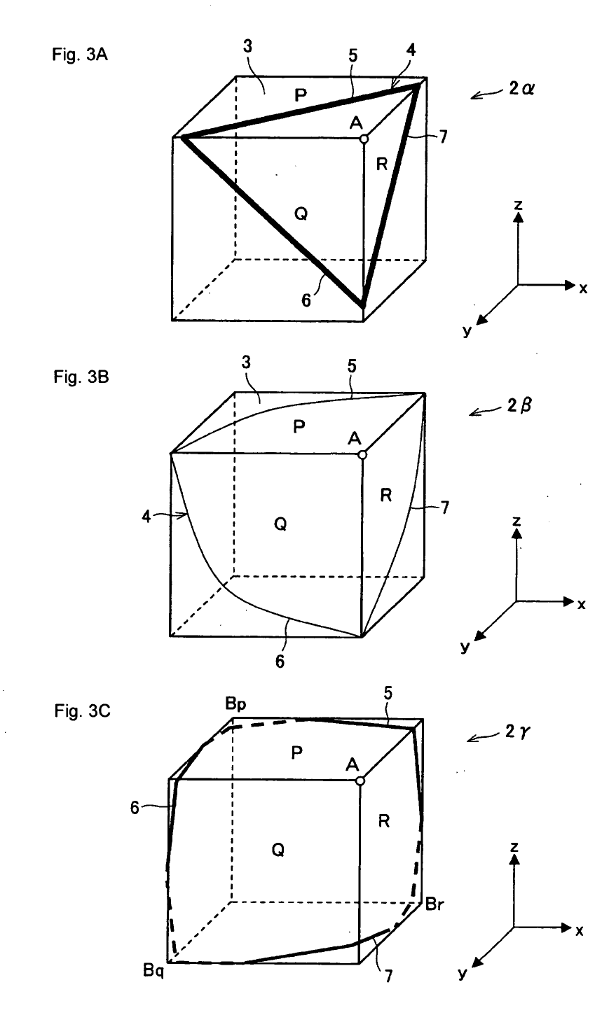

Alternatively, without such guides, the conductors may be wound via the three opposite corners of the three planes from the corner A (see FIG. 3C).

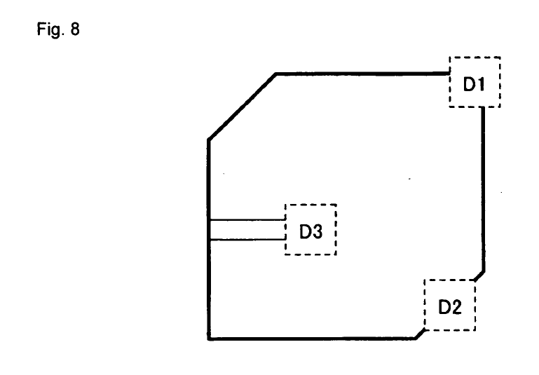

The IC chip may be provided on the surface of the holding material, so as to be inserted to the conductors, as indicated by positions D1 and D2 in FIG. 8. The IC chip may be provided inside the holding block 3, as indicated by position D3 in FIG. 8.

Ultrasonic welding may be performed to connect the antenna 4 and the IC chip. However, any other connecting technique may be employed.

The noncontact data transmitter and receiver may be formed as shown in FIG. 3A.

That is, for example, in the noncontact data transmitter and receiver 2α, the first conductor unit 5 is formed along the plane P (on the plane P), the second conductor unit 6 is formed along the plane Q (on the plane Q), and the third conductor unit 7 is formed along the plane R (on the plane R). The first conductor unit 5 extends along a diagonal line on the plane P that does not include the corner A. The second conductor unit 6 extends along a diagonal line on the plane Q that does not include the corner A. The third conductor unit 7 extends along a diagonal line on the plane R that does not include the corner A.

It is also possible to employ a structure shown in FIG. 3B. That is, for example, in a noncontact data transmitter and receiver 2α, the first conductor unit 5 is formed along the plane P (on the plane P), the second conductor unit 6 is formed along the plane Q (on the plane Q), and the third conductor unit 7 is formed along the plane R (on the plane R).

The first conductor unit 5 extends along the circumferential portion of a quadrant on the plane P that includes the corner A. The second conductor unit 6 extends along the circumferential portion of a quadrant on the plane Q that includes the corner A. The third conductor unit 7 extends along the circumferential portion of a quadrant on the plane R that includes the corner A. With this structure, the areas of the respective projection figures in the x-direction, the y-direction, and the z-direction of the antenna 4 are also uniform, and the above described effects can be achieved.

The noncontact data transmitter and receiver may also be formed as shown in FIG. 3C. That is, for example, in the noncontact data transmitter and receiver 2γ, the first conductor unit 5 extends from one of the two sides of the plane P that include the corner A (from the vicinity of the opposite end of the side from the corner A) to the other one of the two sides of the plane P that include the corner A (to the vicinity of the opposite end of the side from the corner A) through the opposite corner Bp from the corner A. The second conductor unit 6 extends from one of the two sides of the plane Q that include the corner A (from the vicinity of the opposite end of the side from the corner A) to the other one of the two sides of the plane Q that include the corner A (to the vicinity of the opposite end of the side from the corner A) through the opposite corner Bq from the corner A. The third conductor unit 7 extends from one of the two sides of the plane R that include the corner A (from the vicinity of the opposite end of the side from the corner A) to the other side of the two sides of the plane R that include the corner A (to the vicinity of the opposite end of the side from the corner A) through the opposite corner Br from the corner A. With this arrangement, the first conductor unit 5 extends along the plane P, the second conductor unit 6 extends along the plane Q, and the third conductor unit 7 extends along the plane R, so that the first through third conductor units 5 through 7 form a loop.

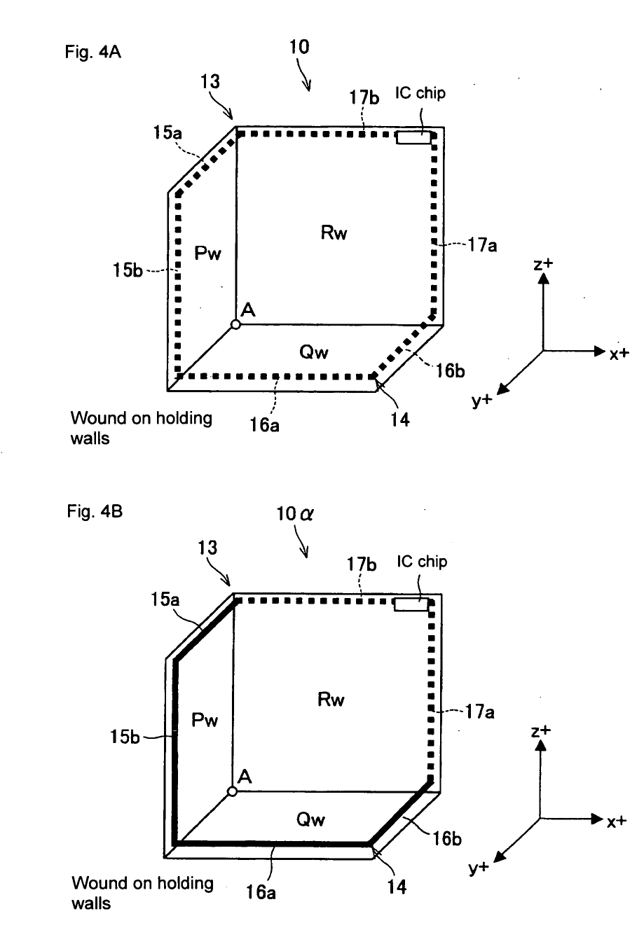

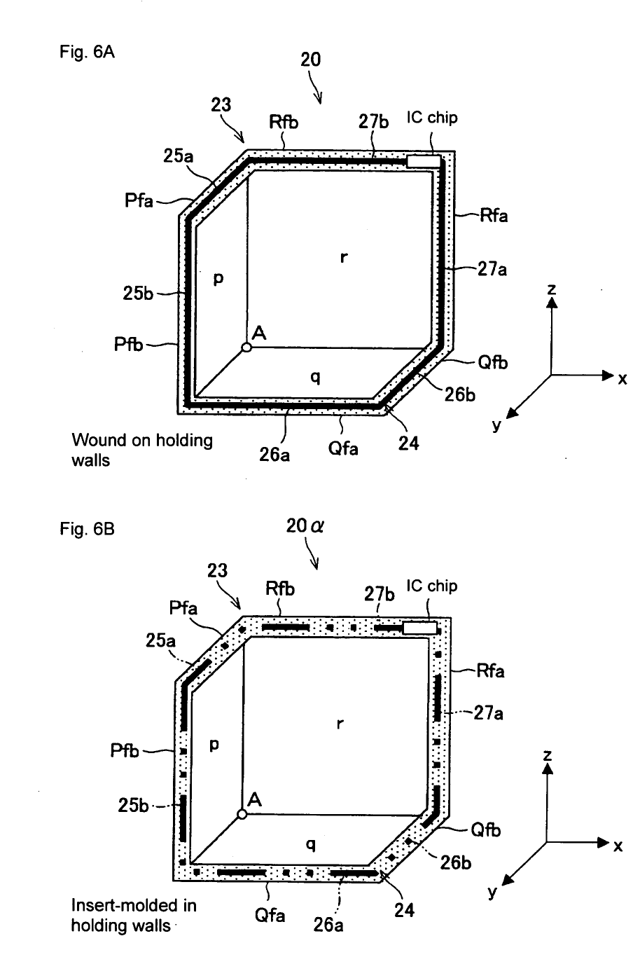

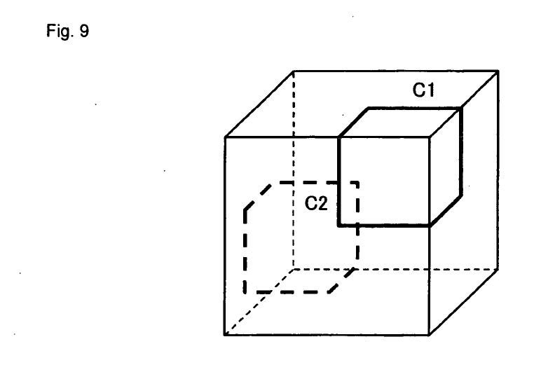

FIG. 9 shows an example of the noncontact data transmitter and receiver attached to an object. As shown in FIG. 9, the noncontact data transmitter and receiver may be attached to corner C1 inside the box to house an ID object, or may be attached to two corners C1 and C2 (in this manner, the reception range is widened). It is of course possible to attach the noncontact data transmitter and receiver to the exterior of the box, or to a given portion of a cushioning material to be packed together with an ID object in the box (to a corner of a styrene foam material, for example). Alternatively, the noncontact data transmitter and receiver may be attached directly to an ID object. In the cases where the noncontact data transmitter and receiver is attached to the exterior of the box or directly to an ID object, the structures shown in FIGS. 4A, 4B, 6A, and 6B or other suitable structures can be employed.

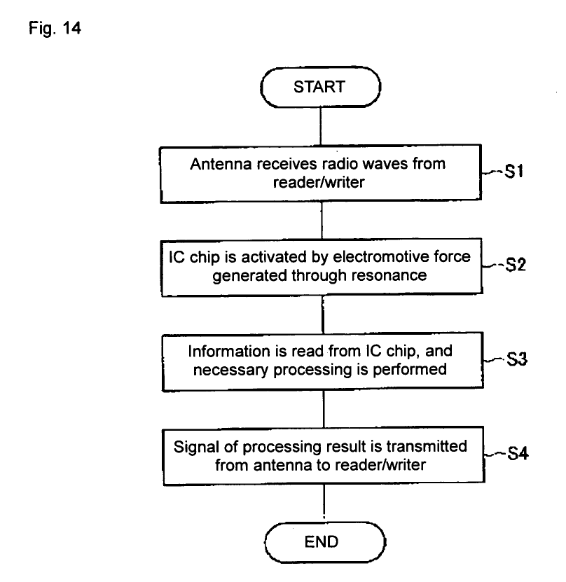

The noncontact data transmitter and receiver 2 may perform an operation shown in FIG. 14, for example. First, the antenna 4 receives radio waves from a reader/writer (S1). The IC chip is activated by the electromotive force caused by resonance (S2). The information in the IC chip is read out, and necessary procedures are carried out (S3). The signal indicating the processing result is transmitted from the antenna 4 to the reader/writer (S4).

[Second Embodiment]

A noncontact data transmitter and receiver in accordance with a second embodiment of the present invention has a holding material formed with three connected holding walls. This structure is shown in FIG. 4A. The noncontact data transmitter and receiver 10 includes an antenna device and an IC chip. The antenna device is formed with an antenna 14 and a holding material. The antenna 14 includes first conductors 15a and 15b (a first conductor unit), second conductors 16a and 16b (a second conductor unit), and third conductors 17a and 17b (a third conductor unit). In this noncontact data transmitter and receiver 10, the first through third conductor units form a loop-like structure, and are connected to the IC chip.

The noncontact data transmitter and receiver 10 includes the antenna 14 and the IC chip that performs data processing, and communicates with external devices through radio waves or electromagnetic waves. For example, upon receipt of radio waves (including a control signal) from an external device, the noncontact data transmitter and receiver 10 generates (induced) electromotive force by virtue of the operation of the antenna of the noncontact data transmitter and receiver 10. Using the electromotive force, the IC chip performs data processing in accordance with the control signal, and the processing result is transmitted from the antenna 14 through carrier waves.

The holding material 13 has three holding walls Pw, Qw, and Rw. The holding walls Pw, Qw, and Rw are designed to share corner A and be perpendicular to one another. The holding material 13 holds conductor units 15 through 17 in a wound state.

The IC chip is also attached to the holding material 13. The holding material 13 can be formed by bending a sheet made of polyimide or other suitable material (described later).

The normal directions of the holding walls Pw, Qw, and Rw are x+-direction, z+-direction, and y+-direction, and the opposite directions to the normal directions are x−-direction, z−-direction, and y−-direction, respectively.

The first conductor unit 15 (15a and 15b) is placed along the inner face (the face on the x− side) of the holding wall Pw (on the inner face of Pw). The second conductor unit 16 (16a and 16b) is placed along the inner face (the face on the z− side) of the holding wall Qw (on the inner face of Qw). The third conductor unit 17 (17a and 17b) is placed along the inner face (the face on the y− side) of the holding wall Rw (on the inner face of Rw). The first conductors 15a and 15b are placed in the vicinities of two sides of the inner face of the holding wall Pw, with the two sides not including the corner A. Accordingly, the first conductors 15a and 15b are arranged parallel to the two sides, respectively (the first conductor 15a extends in the y-direction, while the first conductor 15b extends in the z-direction). The second conductors 16a and 16b are placed in the vicinities of two sides of the inner face of the holding wall Qw, with the two sides not including the corner A. Accordingly, the second conductors 16a and 16b are arranged parallel to the two sides (the second conductor 16a extends in the x-direction, while the second conductor 16b extends in the y-direction). The third conductors 17a and 17b are placed in the vicinities of two sides of the inner face of the holding wall Rw, with the two sides not including the corner A. Accordingly, the third conductors 17a and 17b are arranged parallel to the two sides (the third conductor 17a extends in the z-direction, while the third conductor 17b extends in the x-direction).

With the holding walls having uniform square shapes, the figures obtained by projecting the antenna 14 in the x-, y-, and z-directions have uniform areas, and the areas are the maximum areas that can be achieved with respect to the volume of the holding material 13. Accordingly, the antenna 14 can receive radio waves (signals) with high intensity from any direction, and the reception accuracy is uniform in all the directions.

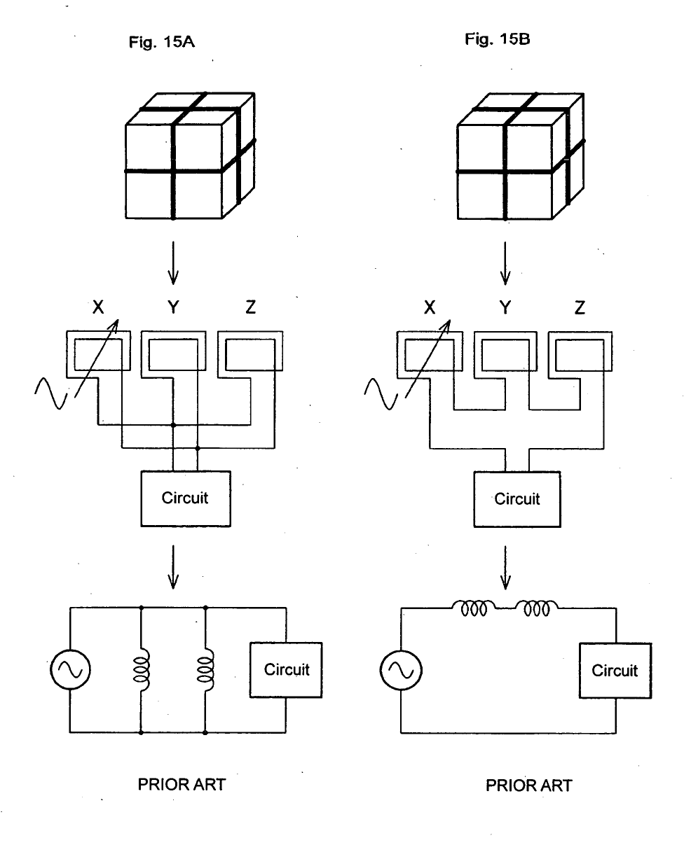

Although the conductor units are placed on the inner faces of the holding walls in FIG. 15A, one or all of the conductor units may be formed on the outer faces of the holding walls (the face on the x+-side of Pw, the face on the y+-side of Qw, and the face on the z+-side of Rw), as shown in FIG. 4B.

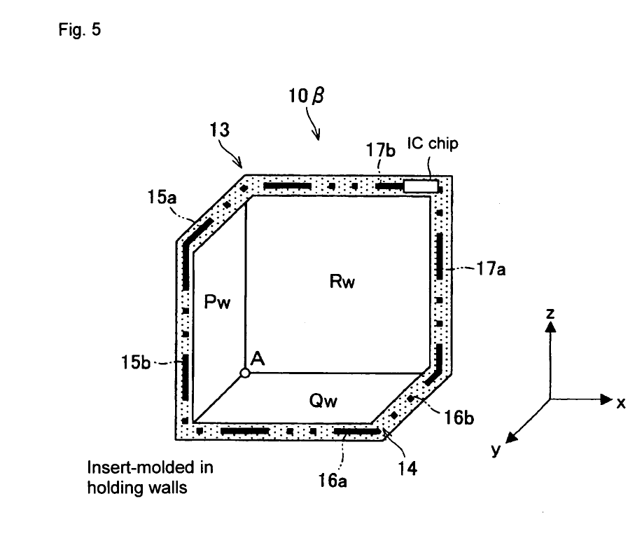

The noncontact data transmitter and receiver of this embodiment may have a structure shown in FIG. 5. That is, for example, in a noncontact data transmitter and receiver 10b, the first conductor unit 15 (15a and 15b) is insert-molded at the locations of the inside of the holding wall Pw corresponding to the vicinities of two sides of the outer face of the holding wall Pw, with the two sides not including the corner A. The second conductor unit 16 (16a and 16b) is insert-molded at the locations of the inside of the holding wall Qw corresponding to the vicinities of two sides of the outer face of the holding wall Qw, with the two sides not including the corner A. The third conductor unit 17 (17a and 17b) is insert-molded at the locations of the inside of the holding wall Rw corresponding to the vicinities of two sides of the outer face of the holding wall Rw, with the two sides not including the corner A.

Each of the holding walls for example has grooves or step portions at the locations at which the conductors are to be placed, so that the conductors can be easily wound and maintain a good wound state (see FIGS. 7A and 7B). Also, guides through which the conductors extend may be provided at the corners at which the conductors are bent. Alternatively, without such guides, the conductors may be wound via the three opposite corners of the three planes from the corner A.

The noncontact data transmitter and receiver 10 of this embodiment may be attached directly to an ID object or to (either the inside of the outside of) the packing box of an ID object. The noncontact data transmitter or receiver 10 may also be attached to a given portion of a cushioning material to be packed together with an ID object in the box (to a corner of a styrene foam material, for example).

[Third Embodiment]

A noncontact transmitter and receiver of a third embodiment of the present invention has a holding material formed with three connected holding frame units that constitute a holding frame. This structure is shown in FIG. 6A. The noncontact data transmitter and receiver 20 includes an antenna device and an IC chip. The antenna device is formed with an antenna and a holding material. The antenna 24 includes first conductors 25a and 25b (a first conductor unit), second conductors 26a and 26b (a second conductor unit), and third conductors 27a and 27b (a third conductor unit). In this noncontact data transmitter and receiver 20, the first through third conductor units form a loop-like structure, and are connected to the IC chip.

The noncontact data transmitter and receiver 20 includes the antenna 24 and the IC chip that performs data processing, and communicates with external devices through radio waves or electromagnetic waves. For example, upon receipt of radio waves (including a control signal) from an external device, the noncontact data transmitter and receiver 20 generates (induced) electromotive force by virtue of the operation of the antenna of the noncontact data transmitter and receiver 20. Using the electromotive force, the IC chip performs data processing in accordance with the control signal, and the processing result is transmitted from the antenna 24 through carrier waves. 100561 The holding material 23 includes a first holding frame unit Pf (Pfa and Pfb), a second holding frame unit Qf (Qfa and Qfb), and a third holding frame unit Rf (Rfa and Rfb). The holding material 23 holds the conductor units 25 through 27 in a wound state. Each of the holding frame units is made of polyimide or other suitable material. The IC chip is also attached to the holding material 23. As shown in FIG. 6A, the holding frame units have uniform square shapes. Three virtual planes (hypothetical planes that do not actually exist) that share the point A and are perpendicular to one another are set as planes p, q, and r. The normal directions of the planes p, q, and r are set as x-, z-, and y-directions, respectively.

The first holding frame unit Pf (Pfa and Pfb) is placed along the plane p, the second holding frame unit Qf (Qfa and Qfb) is placed along the plane q, and the third holding frame unit Rf (Rfa and Rfb) is placed along the plane r. Further, the first holding frame unit Pf (Pfa and Pfb) is placed in the vicinities of two sides of the plane p, with the two sides not including the corner A. Accordingly, the first holding frame unit Pf is arranged parallel to the two sides (the first conductor 25a extends in the y-direction, while the first conductor 25b extends in the z-direction). The second holding frame unit Qf (Qfa and Qfb) is placed in the vicinities of two sides of the plane q, with the two sides not including the corner A. Accordingly, the second holding frame unit Qf is arranged parallel to the two sides (the second conductor 26a extends in the x-direction, while the second conductor 26b extends in the y-direction). The third holding frame unit Rf (Rfa and Rfb) is placed in the vicinities of two sides of the plane r, with the two sides not including the corner A. Accordingly, the third holding frame unit Rf is arranged parallel to the two sides (the third conductor 27a extends in the z-direction, while the third conductor 27b extends in the x-direction).

The first conductor unit 25 (25a and 25b) is placed on the first holding frame unit Pf (Pfa and Pfb), the second conductor unit 26 (26a and 26b) is placed on the second holding frame unit Qf (Qfa and Qfb), and the third conductor unit 27 (27a and 27b) is placed on the third holding frame unit Rf (Rfa and Rfb).

With the planes p through r having uniform square shapes, the figures obtained by projecting the antenna 24 in the x-, y-, and z-directions have uniform areas, and the areas are the maximum areas that can be achieved with respect to the volume of the holding material 23. Accordingly, the antenna 24 can receive radio waves (signals) with high intensity from any direction, and the reception accuracy is uniform in any direction.

Each of the holding frame units for example has grooves or step portions at the locations at which the conductors are to be placed, so that the conductors can be easily wound and maintain a good wound state (see FIG. 7C). Also, guides through which the conductors extend may be provided at the corners at which the conductors are bent.

Alternatively, without such guides, the conductors may be wound via the three opposite corners of the three planes from the corner A.

The noncontact data transmitter and receiver of this embodiment may have a structure shown in FIG. 6B. That is, for example, in a noncontact data transmitter and receiver 20a, the first conductor unit 25 (25a and 25b) is insert-molded inside the first holding frame unit Pf (Pfa and Pfb). The second conductor unit 26 (26a and 26b) is insert-molded inside the second holding frame unit Qf (Qfa and Qfb). The third conductor unit 27 (27a and 27b) is insert-molded inside the third holding frame unit Rf (Rfa and Rfb).

The noncontact data transmitter and receiver 20 of this embodiment may be attached directly to an ID object or to (either the inside of the outside of) the packing box of an ID object. The noncontact data transmitter or receiver 20 may also be attached to a given portion of a cushioning material to be packed together with an ID object in the box (to a corner of a styrene foam material, for example).

[Fourth Embodiment]

In this embodiment, a communicator sheet that forms the noncontact data transmitter and receiver 10 (10□, 10□) of the second embodiment is described. A three-dimensional noncontact data transmitter and receiver can be formed from a two-dimensional communicator sheet. With this structure, not only the production costs but also the storage and transportation costs can be dramatically reduced. In this embodiment, the sheet plane is x-y plane, and the direction perpendicular to the sheet plane is z-direction.

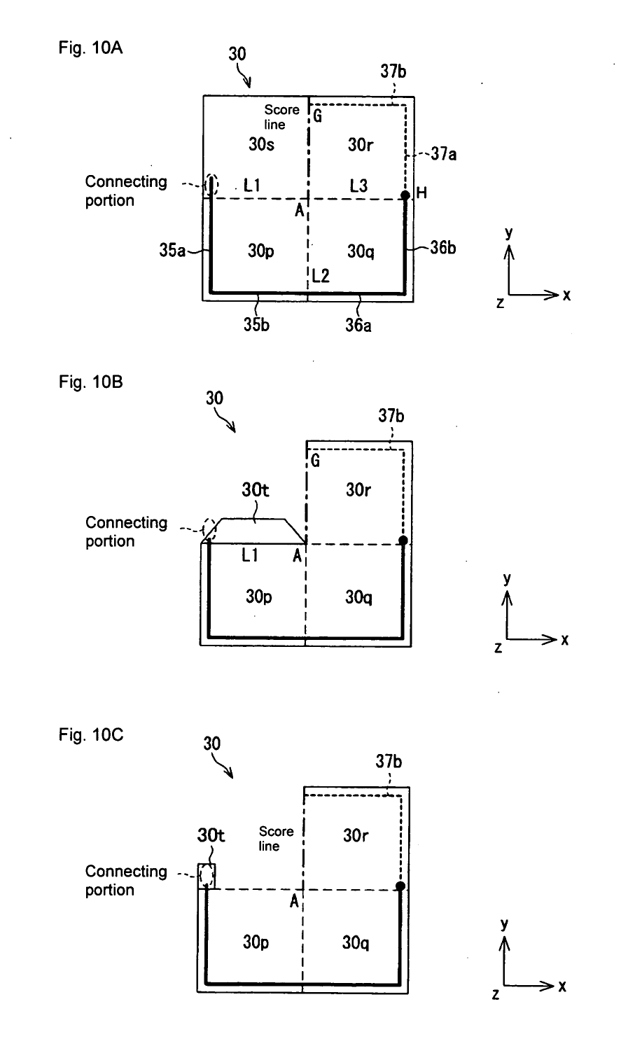

A communicator sheet 30 shown in FIG. 10A is formed with four partial sheets 30p, 30q, 30r, and 30s (a connecting sheet) that share the corner A and are connected to one another. The partial sheets have uniform square shapes. The partial sheets 30p, 30q, and 30r have a first conductor unit 35 (35a and 35b), a second conductor unit 36 (36a and 36b), and a third conductor unit 37 (37a and 37b), respectively. Although not shown in the drawing, an IC chip that is connected to the conductor units is attached to the communicator sheet 30. The first through third conductor units 35 through 37 are connected directly to one another or are connected to one another via the IC chip. The partial sheets 30s and 30p are adjacent to each other, with line L1 extending through the point A being the boundary. The partial sheets 30p and 30q are adjacent to each other, with line L2 extending through the point A being the boundary. The partial sheets 30q and 30r are adjacent to each other, with line L3 extending through the point A being the boundary. Also, a score line is formed through the boundary between the partial sheet 30r and 30s.

The first conductors 35a and 35b are placed in the vicinities of two sides of the front face of the partial sheet 30p, with the two sides not including the corner A.

Accordingly, the first conductors 35a and 35b are arranged parallel to the two sides, respectively (the first conductor 35a extends in the y-direction, while the first conductor 35b extends in the x-direction). The second conductors 36a and 36b are placed in the vicinities of two sides of the front face of the partial sheet 30q, with the two sides not including the corner A. Accordingly, the second conductors 36a and 36b are arranged parallel to the two sides, respectively (the second conductor 36a extends in the x-direction, while the second conductor 36b extends in the y-direction). The third conductors 37a and 37b are placed in the vicinities of two sides of the back face of the partial sheet 30r, with the two sides not including the corner A. Accordingly, the third conductors 37a and 37b are arranged parallel to the two sides, respectively (the third conductor 37a extends in the y-direction, while the third conductor 37b extends in the x-direction). A connecting portion for the connection with the conductor 35a is provided on the front face of the partial sheet 30s. This connecting portion is a small extended portion at the end of the first conductor 35a on the side of the partial sheet 30s. The second conductor 36b (on the front face of the partial sheet) and the third conductor 37a (on the back face of the partial sheet) are connected to each other with a through-hole H, for example.

This communicator sheet 30 is assembled in the following manner, so that the noncontact data transmitter and receiver of the second embodiment can be produced. First, with the line L2 and the score line being a folding line, folding (forward from the sheet surface) is performed so that the partial sheets 30q and 30r become parallel to the z-direction (the direction perpendicular to the sheets). With the line L3 being the folding line, folding is then performed so that the partial sheet 30r becomes perpendicular to the partial sheets 30q and 30p (the score line is placed on the line L1). With the line L1 being the folding line, folding is further performed so that the partial 30s is placed on the partial sheet 30r. With this arrangement, the end portion G of the third conductor 37b placed on the back face of the partial sheet 30r is overlapped on the connecting portion placed on the partial sheet 30s, and the antenna 14 is formed as shown in FIG. 4B for example. That is, the partial sheet 30p forms the holding wall Pw and the first conductor unit 15 shown in FIG. 4B, the partial sheet 30q forms the holding wall Qw and the second conductor unit 16 shown in FIG. 4B, and the partial sheet 30r forms the holding wall Rw and the third conductor unit 17 shown in FIG. 4B.

The communicator sheet 30 may be modified as shown in FIGS. 10B and 10C.

The partial sheet 30s of FIG. 10A is designed in the form of a small trapezoid as a margin 30t (a connecting sheet), and the connecting portion is formed on the margin 30t (see FIG. 10B). The end portion G of the third conductor 37b placed on the back face of the partial sheet 30r is overlapped on the connecting portion of the margin 30t, so as to form the antenna 14. The margin 30t may be only slightly larger than the connecting portion (see FIG. 10C).

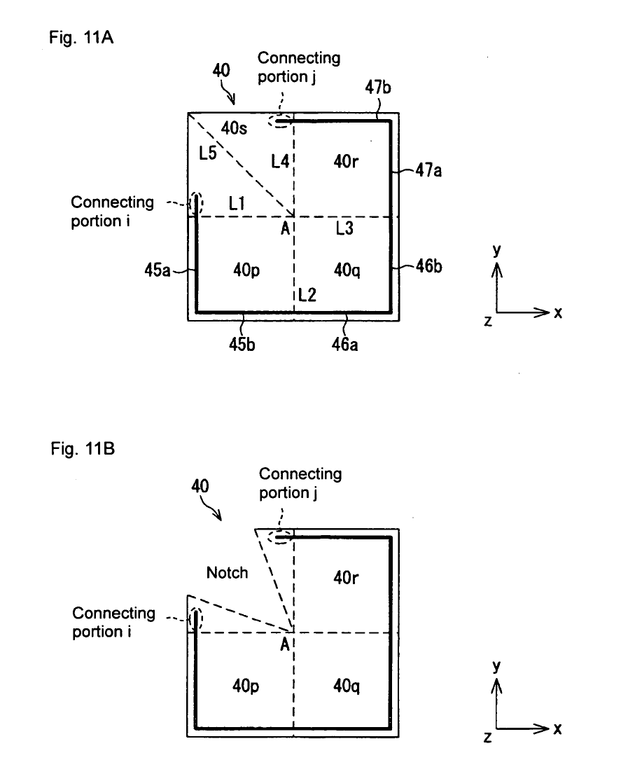

The communicator sheet in accordance with this embodiment may be formed as shown in FIG. 11A. A communicator sheet 40 is formed with four partial sheets 40p, 40q, 40r, and 40s (a connecting sheet) that share the point A and are connected to one another.

The partial sheets have uniform square shapes. The partial sheets 40p, 40q, and 40r include a first conductor unit 45 (45a and 45b), a second conductor unit 46 (46a and 46b), and a third conductor unit 47 (47a and 47b), respectively. Although not shown in the drawing, an IC chip to be connected to the conductor units is provided on the communicator sheet 40. The first through third conductor units 45 through 47 are connected directly to one another or are connected to one another via the IC chip. The partial sheets 40s and 40p are adjacent to each other, with line L1 extending through the point A being the boundary. The partial sheets 40p and 40q are adjacent to each other, with line L2 extending through the point A being the boundary. The partial sheets 40q and 40r are adjacent to each other, with line L3 being the boundary. The partial sheets 40r and 40s are adjacent to each other, with line L4 being the boundary. Further, a diagonal line including the point A on the partial sheet 40s is line L5.

The first conductors 45a and 45b are placed in the vicinities of two sides of the front face of the partial sheet 40p, with the two sides not including the corner A.

Accordingly, the first conductors 45a and 45b are arranged parallel to the two sides, respectively (the first conductor 45a extends in the y-direction, while the first conductor 45b extends in the x-direction). The second conductors 46a and 46b are placed in the vicinities of two sides of the front face of the partial sheet 40q, with the two sides not including the corner A. Accordingly, the second conductors 46a and 46b are arranged parallel to the two sides, respectively (the second conductor 46a extends in the x-direction, while the second conductor 46b extends in the y-direction). The third conductors 47a and 47b are placed in the vicinities of two sides of the front face of the partial sheet 40r, with the two sides not including the corner A. Accordingly, the third conductors 47a and 47b are arranged parallel to the two sides, respectively (the third conductor 47a extends in the y-direction, while the third conductor 47b extends in the x-direction). A connecting portion i for the connection with the conductor 45a is provided on the front face of the partial sheet 40s. This connecting portion i is a small extended portion at the end of the first conductor 45a on the side of the partial sheet 40s. Further, a connecting portion j for the connection with the conductor 47b is provided on the front face of the partial sheet 40s. This connecting portion j is a small extended portion of the third conductor 47b on the side of the partial sheet 40s.

This communicator sheet 40 is assembled in the following manner, so that the noncontact data transmitter and receiver of the second embodiment can be produced.

First, with the line L2 and the line L4 (forming one straight line) being a folding line, folding backward from the sheet face is performed so that the partial sheets 40q and 40r become parallel to the z-direction (the direction perpendicular to the sheets). With the line L5 being the folding line, the partial sheet 40s is folded inward, so that the line L4 is overlapped on the line L1. In this manner, the connecting portion i and the connecting portion j provided on the partial sheet 40s are overlapped on each other, and the antenna 14 shown in FIG. 4A is formed. Accordingly, the partial sheet 40p forms the holding wall Pw and the first conductor unit 15 shown in FIG. 4A, the partial sheet 40q forms the holding wall Rw and the third conductor unit 17 shown in FIG. 4A, and the partial sheet 40r forms the holding wall Qw and the second conductor unit 16 shown in FIG. 4A.

As shown in FIG. 11B, the communicator sheet 40 may have a notch formed in the partial sheet 40s (the connecting sheet) of FIG. 11 A by cutting the partial sheet 40s along a line extending from the vicinity of the connecting portion i to the point A and a line extending from the vicinity of the connecting portion j to the point A.

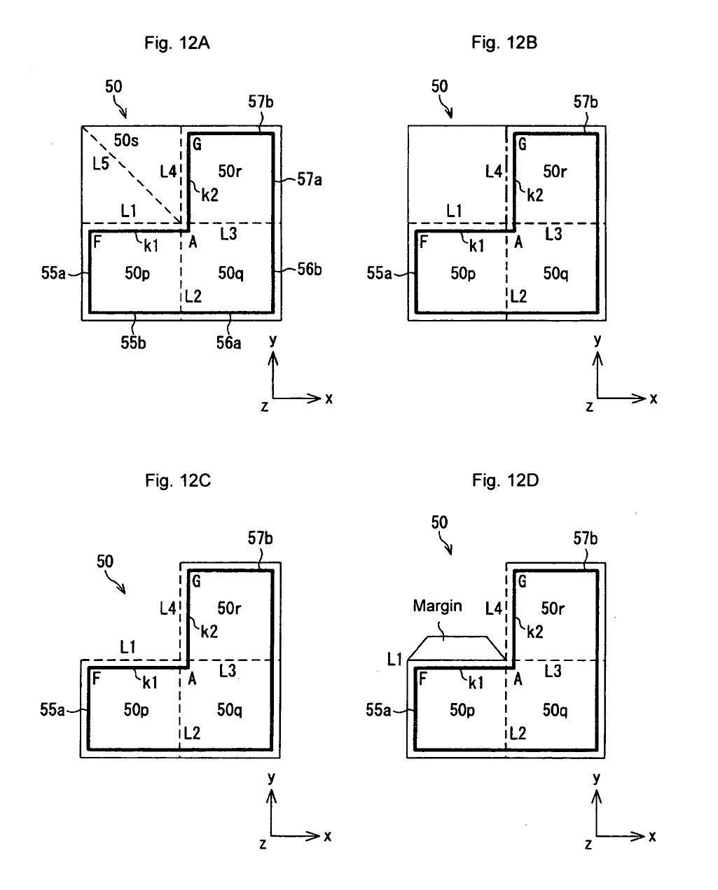

The communicator sheet in accordance with this embodiment may also be formed as shown in FIG. 12A. A communicator sheet 50 is formed with four partial sheets 50p, 50q, 50r, and 50s that share point A and are connected to one another. The partial sheets have uniform square shapes. The partial sheets 50p, 50q, and 50r include a first conductor unit 55 (55a and 55b), a second conductor unit 56 (56a and 56b), and a third conductor unit 57 (57a and 57b), respectively. Although not shown in the drawing, an IC chip to be connected to the conductor units is provided on the communicator sheet 50.

The first through third conductor units 55 through 57 are connected directly to one another or are connected to one another via the IC chip. The partial sheets 50s and 50p are adjacent to each other, with line L1 extending through the point A being the boundary. The partial sheets 50p and 50q are adjacent to each other, with line L2 extending through the point A being the boundary. The partial sheets 50q and 50r are adjacent to each other, with line L3 being the boundary. The partial sheets 50r and 50s are adjacent to each other, with line L4 being the boundary. Further, a diagonal line including the point A on the partial sheet 50s is line L5.

The first conductors 55a and 55b are placed in the vicinities of two sides of the front face of the partial sheet 50p, with the two sides not including the corner A.

Accordingly, the first conductors 55a and 55b are arranged parallel to the two sides, respectively (the first conductor 55a extends in the y-direction, while the first conductor 55b extends in the x-direction). The second conductors 56a and 56b are placed in the vicinities of two sides of the front face of the partial sheet 50q, with the two sides not including the corner A. Accordingly, the second conductors 56a and 56b are arranged parallel to the two sides, respectively (the second conductor 56a extends in the x-direction, while the second conductor 56b extends in the y-direction). The third conductors 57a and 57b are placed in the vicinities of two sides of the front face of the partial sheet 50r, with the two sides not including the corner A. In this manner, the third conductors 57a and 57b are arranged parallel to the two sides, respectively (the third conductor 57a extends in the y-direction, while the third conductor 57b extends in the x-direction).

Further, a connecting portion k1 to be connected to an end portion F of the conductor 55a is provided along the line L1 on the front face of the partial sheet 50p. A connecting portion k2 to be connected to an end portion G of the conductor 57b is provided along the line L4 on the front face of the partial sheet 50r. The two connecting portions k1 and k2 are connected in the vicinity of the corner A.

This communicator sheet 50 is assembled in the following manner, so that the noncontact data transmitter and receiver of the second embodiment can be produced.

First, with the line L2 and the line L4 (forming one straight line) being the folding line, folding backward from the sheet face is performed so that the partial sheets 50q and 50r become parallel to the z-direction (the direction perpendicular to the sheets). With the line L5 being the folding line, the partial sheet 50s is folded inward, and, with the line L3 being the folding line, the partial sheet 50r is folded, so that the partial sheet 50r becomes perpendicular to the partial sheets 50p and the partial sheet 50q. Since the end portion F of the conductor 55a and the end portion G of the conductor 57b are connected with the connecting portions k1 and k2 in the first place, the antenna 14 shown in FIG. 4A is formed. Accordingly, the partial sheet 50p forms the holding wall Pw and the first conductor unit 15 shown in FIG. 4A, the partial sheet 50q forms the holding wall Rw and the third conductor unit 17 shown in FIG. 4A, and the partial sheet 50r forms the holding wall Qw and the second conductor unit 16 shown in FIG. 4A.

In the communicator sheet 50, a score line may be formed through the line L4 of FIG. 12A (see FIG. 12B), or the partial sheet 50s of FIG. 12A may be replaced with a notch (see FIG. 12C), or the partial sheet 50s of FIG. 12A may be made smaller and used as a margin (see FIG. 12D). In any of the above cases, with the line L2 and the line L4 (forming one straight line) being the folding line, folding backward from the sheet face is performed so that the partial sheets 50q and 50r become parallel to the z-direction (the direction perpendicular to the sheet). With the line L3 being the folding line, the partial sheet 50r is folded so that the partial sheet 50r becomes perpendicular to the partial sheet 50p and the partial sheet 50q (so that the line L1 and the line L4 are overlapped on each other). Since the end portion F of the conductor 55a and the end portion G of the conductor 57b are connected with the connecting portions k1 and k2 in the first place, the antenna 14 as shown in FIG. 4A is formed.

In any of the above described structures, an adhesive face may be formed on at least a part of one or more of the partial sheets 50, so that the partial sheets can be attached to a packing box for an ID object. The communicator sheet 50 of this embodiment may be attached directly to an ID object or to (either the inside of the outside of) the packing box of an ID object. The communicator sheet 50 of this embodiment may also be attached to a given portion of a cushioning material to be packed together with an ID object in the box (to a corner of a styrene foam material, for example).

Although the communicator sheet of this embodiment includes an IC chip, it may be formed as an antenna sheet only with conductors or antennas (not including an IC chip). In such a case, an IC chip can be attached to the structure after the antenna sheet is assembled. The antenna sheet may have any of the structures shown in FIGS. 10A through C and FIGS. 11A and 11B.

[Fifth Embodiment]

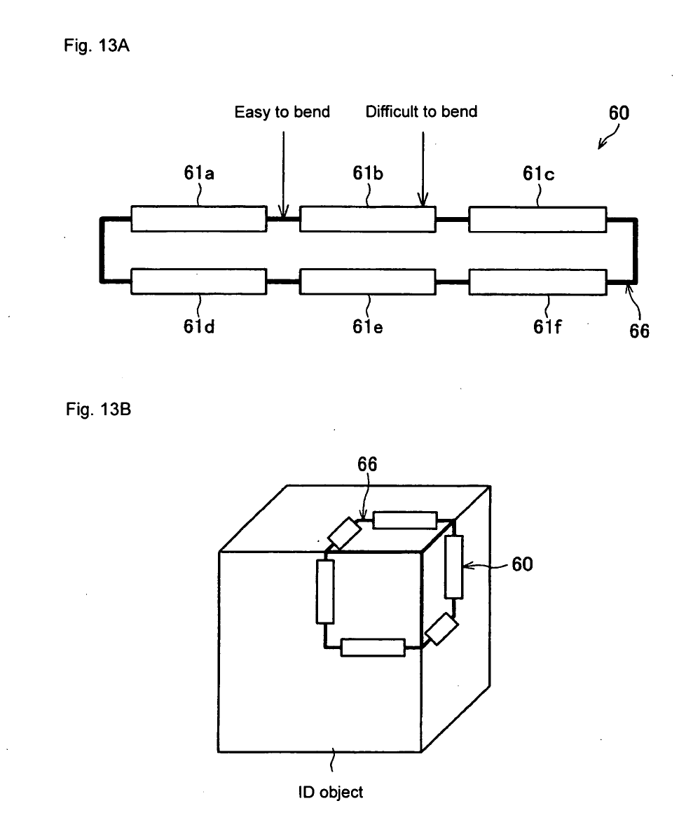

To produce the noncontact data transmitter and receiver of the third embodiment, a communicator loop shown in FIG. 13A can be formed. A communicator loop 60 has six holding materials 61a through 61f attached at intervals to a loop-like conductor unit 66.

Although not shown, an IC chip to be connected to the conductor unit is attached to the communicator loop 60. The conductor unit 66 is made of a material that easily bends, while the holding members 61a through 61f are made of a material that is difficult to bend. With this arrangement, the communicator loop 60 can have the following three-dimensional structure. Planes p, q, and r having uniform square shapes are virtual planes that share corner A and are perpendicular to one another. The holding materials 61a and 61b are arranged along the plane p, the holding materials 61c and 61d are arranged along the plane q, and the holding materials 61e and 61f are arranged along the plane r. The holding materials 61a and 61b are placed in the vicinity of two sides of the plane p, with the two sides not including the corner A. Accordingly, the holding materials 61a and 61b are arranged parallel to the two sides, respectively. The holding materials 61c and 61d are placed in the vicinity of two sides of the plane q, with the two sides not including the corner A. Accordingly, the holding materials 61c and 61d are arranged parallel to the two sides, respectively. The holding materials 61e and 61f are placed in the vicinity of two sides of the plane r, with the two sides not including the corner A. Accordingly, the holding materials 61e and 61f are arranged parallel to the two sides, respectively. The conductor unit 66 is looped through the respective holding materials 61a through 61f.

With this three-dimensional structure, the communicator loop 60 can be attached to an ID object (see FIG. 13B), and the same effects as those of the third embodiment can be achieved.

A communicator loop can be formed only with conductors, without such holding materials as the holding materials 61 a through 61f of FIG. 13A. In this case, folding lines or score lines are formed at several positions in the conductor unit. Alternatively, several conductors made of different materials with various degrees of flexibility may be connected and used as a conductor unit. With this arrangement, a two-dimensional structure can be turned into the above three-dimensional structure. Also, a communicator loop can be formed by looping a conductor covered with a coating. In this case, folding lines or score lines are formed at several positions in the coating. The coating may be formed with different coating materials with various degrees of flexibility. With this arrangement, a two-dimensional structure can be turned into the above three-dimensional structure. Further, a fixing member that hardly bends may be attached to a loop-like constant conductor. In this case, protrusions can be formed on the conductor, so as to prevent the fixing member from shifting, or grooves can be formed in the fixing member. With such arrangement, transportation becomes smoother.

The communicator loop 60 of this embodiment may be attached directly to an ID object or to (either the inside of the outside of) the packing box of an ID object. The communicator loop 60 of this embodiment may also be attached to a given portion of a cushioning material to be packed together with an ID object in the box (to a corner of a styrene foam material, for example).

As described above, with the antenna device of the present invention, the length of the loop formed by a three-dimensional antenna can be dramatically reduced, and the power loss can also be dramatically reduced. More specifically, the antenna device of the present invention can receive radio waves from various directions and generate large electromotive force. Accordingly, if the antenna device is implemented in a noncontact data transmitter and receiver, for example, the data transmission and reception capacity can be increased. Furthermore, the antenna device has a very simple structure, with three conductor units parallel to the respective planes being formed into a loop. Thus, the production costs can be reduced. Also, the antenna device may be converted from a two-dimensional structure to a three-dimensional structure. In this manner, not only the production costs but also the storage and transportation costs can be dramatically reduced.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An antenna device comprising:
a holding material; and
first through third conductor units that are provided on the holding material,
wherein: the holding material has first through third planes that share one corner and are perpendicular to one another;
the first conductor unit is placed along the first plane;
the second conductor unit is placed along the second plane; and
the third conductor unit is placed along the third plane.

2. The antenna device according to claim 1, wherein the first through third conductor units are connected to one another and form a loop-like shape.

3. The antenna device according to claim 2, wherein
an area surrounded by a projection view formed by projecting the first through third conductor units in a normal direction of the first plane, an area surrounded by a projection view formed by projecting the first through third conductor units in a normal direction of the second plane, and an area surrounded by a projection view formed by projecting the first through third conductor units in a normal direction of the third plane are the same.

4. The antenna device according to claim 2, wherein the holding material has a cubic shape.

5. The antenna device according to claim 2, wherein
the first conductor unit is arranged parallel to two sides of the first plane, the two sides not including the corner;
the second conductor unit is arranged parallel to two sides of the second plane, the two sides not including the corner; and
the third conductor unit is arranged parallel to two sides of the third plane, the two sides not including the corner.

6. The antenna device according to claim 2, wherein
the holding material includes a first holding wall that has a first square plane, a second holding wall that has a second square plane, and a third holding wall that has a third square plane.

7. An antenna device comprising:
a first conductor unit:
a second conductor unit that is electrically connected to the first conductor unit;
a third conductor unit that is electrically connected to the first conductor unit and the second conductor unit;
a first holding material that holds at least part of the first conductor unit;
a second holding material that holds at least part of the second conductor unit; and
a third holding material that holds at least part of the third conductor unit,
wherein a plane that includes the first conductor unit, a plane that includes the second conductor unit, and a plane that includes the third conductor unit are perpendicular to one another.

8. The antenna device according to claim 7, wherein the first through third holding members are connected to one another, and form a loop-like shape.

9. An antenna comprising:
a first conductor unit;
a second conductor unit that is electrically connected to the first conductor unit;
a third conductor unit that is electrically connected to the first conductor unit and the second conductor unit;
wherein: first through third planes being three virtual planes that share one point and are perpendicular to one another,
the first through third conductor units are connected to one another;
the first conductor unit is placed along the first plane;
the second conductor unit is placed along the second plane; and
the third conductor unit is placed along the third plane.

10. A noncontact data transmitter and receiver comprising:
an antenna; and
an IC chip that is connected to the antenna, wherein:
the antenna comprises:
a first conductor unit;
a second conductor unit that is electrically connected to the first conductor unit; and
a third conductor unit that is electrically connected to the first conductor unit and the second conductor unit;
wherein: first through third planes being three virtual planes that share one point and are perpendicular to one another,
the first through third conductor units being connected to one another,
the first conductor unit being placed along the first plane,
the second conductor unit being placed along the second plane,
the third conductor unit is placed along the third plane;
the IC chip performs an operation in accordance with a control signal received by the antenna, using electromotive force generated by radio waves including the control signal; and
radio waves for transmitting information recorded on the IC chip are generated from the antenna.

11. An antenna sheet comprising:
first through third partial sheets;
a first conductor unit that is provided on the first partial sheet;
a second conductor unit that is provided on the second partial sheet; and
a third conductor unit that is provided on the third partial sheet;
wherein: folding is performed at an boundary between each two of the first through third partial sheets, so as to arrange the first through third partial sheets in a L-like shape and to form first through third planes that share one point and are perpendicular to one another;
the first conductor unit and the second conductor unit are connected to each other; and
the second conductor unit and the third conductor unit are connected to each other.

12. The antenna sheet according to claim 11, wherein the first conductor unit and the third conductor unit are connected to each other via a connecting unit formed with a conductor.

13. The antenna sheet according to claim 11, wherein:
a connecting sheet connected to at least one of the partial sheets is provided;
a conductor unit connected to at least one of the first conductor unit and the third conductor unit is provided on the connecting sheet; and
the folding enables connection between the first conductor unit and the third conductor unit with the conductor unit provided on the connecting sheet.

14. The antenna sheet according to claim 11, wherein the first through third partial sheets are three connected square sheets sharing the one point, and each of the conductors is arranged parallel to two sides that do not include the one point.
